(19) United States
(12) Patent Application Publication
(10) Pub. No.: US 2010/0278409 A1
(43) Pub. Date: Nov. 4, 2010

(54) HARDWARE TUMOR PHANTOM FOR IMPROVED COMPUTER-AIDED DIAGNOSIS

(75) Inventors: Rafael Wiemker, Kisdorf (DE); Udo Van Stevendaal, Ahrensburg (DE); Thomas Koehler, Norderstedt (DE); Michael Grass, Buchholz in der Norheide (DE)

Correspondence Address: PHILIPS INTELLECTUAL PROPERTY & STANDARDS, P. O. Box 3001, BRIARCLIFF MANOR, NY, 10510, US

(73) Assignee: KONINKLIJKE PHILIPS ELECTRONICS N.V., EINDHOVEN (NL)

(21) Appl. No.: 12/746,552

(22) PCT Filed: Dec. 12, 2008
(86) PCT No.: PCT/IB2008/055271

§ 371 Date: Jun. 7, 2010

Related U.S. Application Data
(60) Provisional application No. 61/015,932, filed on Dec. 21, 2007.

(51) Int. Cl. G06K 9/00

(52) U.S. Cl. 382/131

(57) ABSTRACT

An imaging system (1) includes at least one hardware phantom (52, 54, 56, 58) which includes structural features (s, 82, 92) that mimic different structural features of tumors. A scanner (10) acquires image data for a subject (14) in a region of interest (40) and the at least one hardware phantom. A reconstruction processor (32) processes the image data to generate reconstructed image data representative of the region of interest and of the hardware phantom.

The present application relates to diagnostic imaging. It finds particular application in connection with a hardware phantom and a method for improving diagnosis of malignant tumors and will described with particular reference thereto.

For differential diagnosis between benign and malignant tumors (e.g., lung nodules), the spicularity (irregularity of surface) and vascularity (the way in which a tumor is connected to the surrounding network of blood vessels) are significant clinical parameters. Cancerous (malignant) tumors need sufficient blood supply, cause angiogenesis, and thus tend to show a higher vascularity and spicularity than tumors that are classified as benign.

Imaging techniques, such as computed tomography (CT) and magnetic resonance (MR), are useful for diagnosis of tumors in subjects. Automatic computerized techniques for quantification of spicularity and vascularity are being developed which should facilitate computer aided diagnosis (CAD) of tumors using reconstructed images obtained in an imaging process. These techniques compare image data acquired during scanning of a subject known or suspected of having a tumor with previously acquired data. The spiculi or blood vessels, from which the data for diagnosis are to be acquired, tend to be relatively small, at least in the onset of tumor growth. The computerized quantification of spicularity and vascularity by image processing operators thus tends to be highly dependent on the selected CT (or MR) scan protocol (e.g., tube current, pitch, slice thickness), reconstruction method, image resolution, and the like. There is thus a concern that fine spiculi or blood vessels may be hidden by the resolution or noise level of a certain imaging/reconstruction protocol. The quantitative results may therefore not be comparable between different CT scans and thus lead to erroneous diagnostic results.

The present application provides a new and improved apparatus and method which overcome the above-referenced problems and others.

In accordance with one aspect, an imaging system includes at least one hardware phantom, which includes structural features that mimic different structural features of tumors. A scanner acquires image data for a subject in a region of interest and the at least one hardware phantom. A reconstruction processor processes the image data to generate reconstructed image data representative of the region of interest and of the hardware phantom.

In accordance with another aspect, a method of imaging includes, in the same scan, acquiring image data for a subject in a region of interest together with image data for at least one hardware phantom. The method further includes processing the image data to generate reconstructed image data representative of the region of interest and of the at least one hardware phantom.

In accordance with another aspect, a method of analyzing image data includes computing parameters of structural features of a candidate tumor represented in reconstructed image data acquired in a scan of a subject, computing parameters of structural features of at least one hardware phantom represented in the reconstructed image data acquired in the scan of the subject and estimating an ability to resolve at least some of the structural features of the candidate tumor from the computed parameters of the structural features of the hardware phantom.

One advantage is that the system and method enable more accurate differential diagnosis of tumors.

Another advantage of the disclosed system and method is that computer aided diagnosis techniques are able to account for differences in the detectability of the structures on which the diagnosis is based.

Another advantage is that the diagnosis is able to be independent of patient anatomy, such as thickness and bone density, patient position in the scanner as well as scanning parameters.

Still further advantages of the present invention will be appreciated by those of ordinary skill in the art upon reading and understanding the following detailed description.

The invention may take form in various components and arrangements of components, and in various steps and arrangements of steps. The drawings are only for purposes of illustrating the preferred embodiments and are not to be construed as limiting the invention.

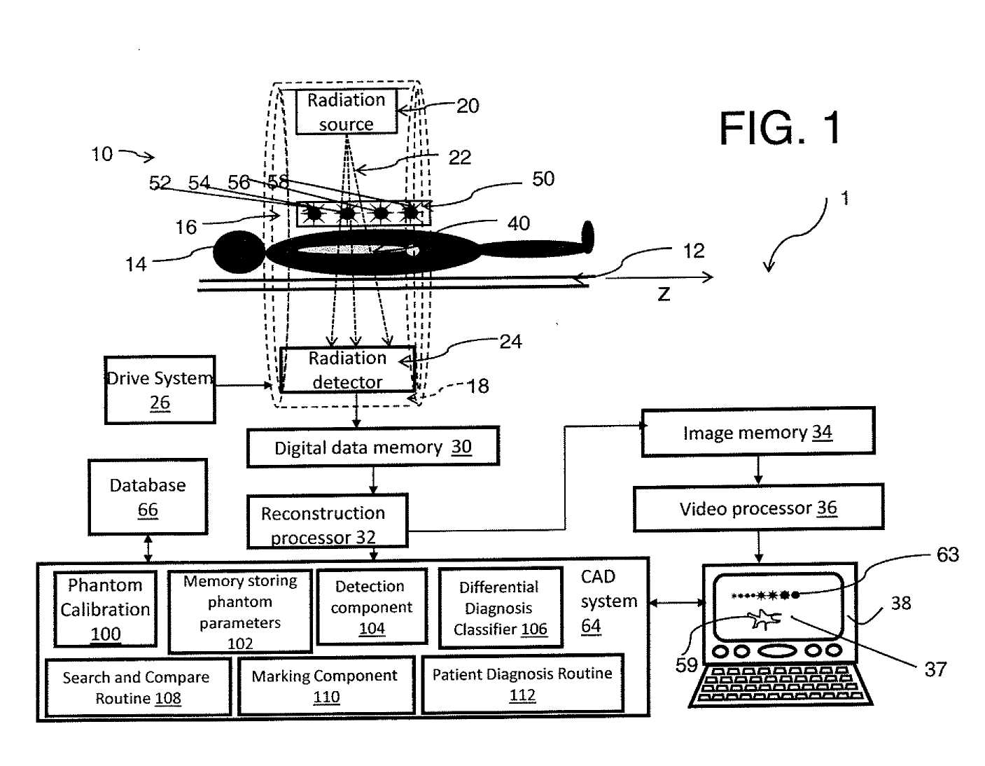

FIG. 1 is a schematic elevational view of an imaging system in accordance with one aspect of one embodiment;

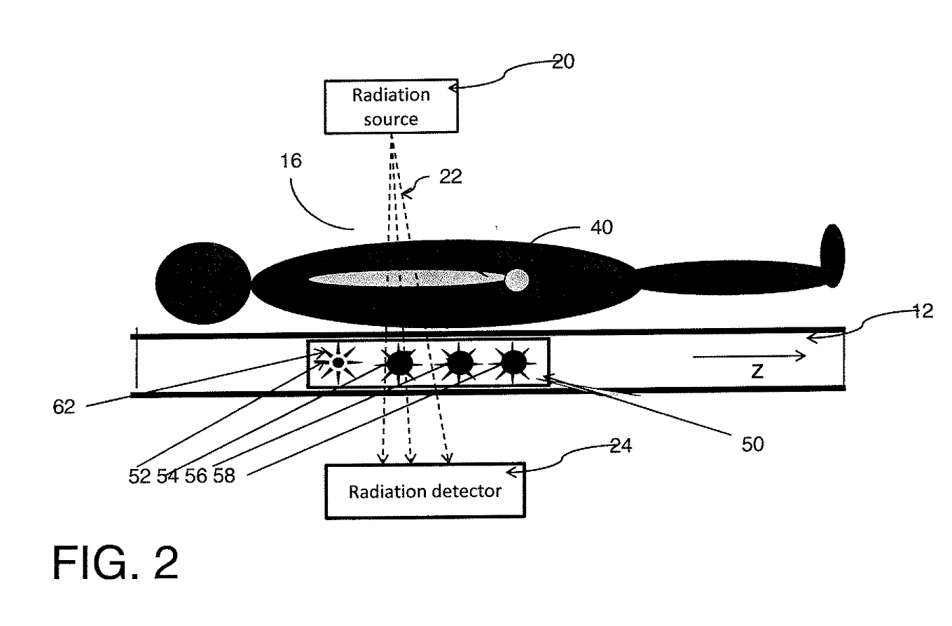

FIG. 2 is a schematic elevational view of an imaging system in accordance with another embodiment;

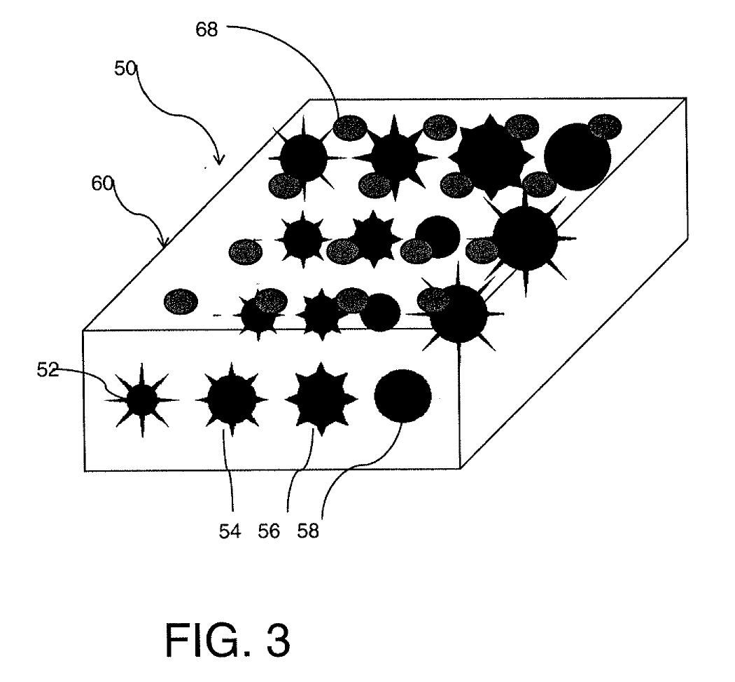

FIG. 3 is an enlarged perspective view of a hardware phantom assembly in accordance with another embodiment;

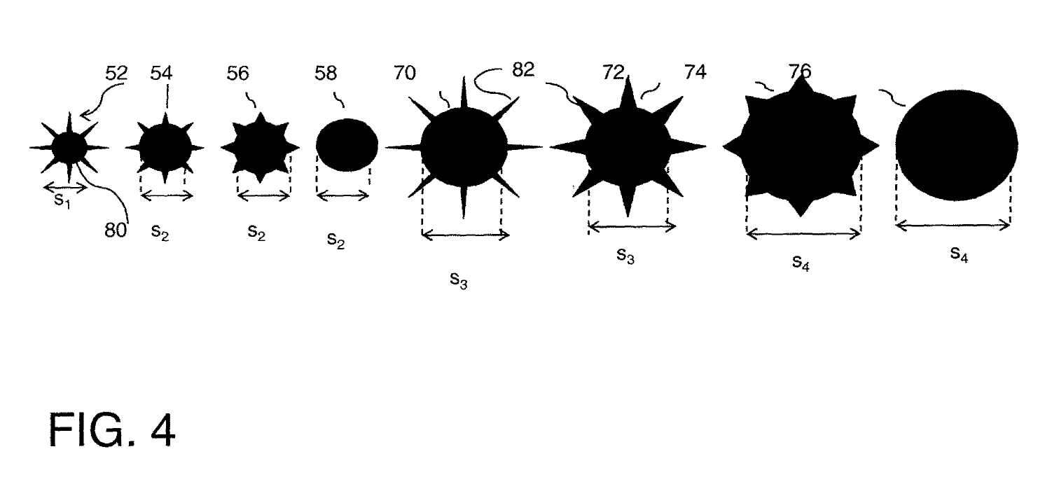

FIG. 4 is an enlarged sectional view of a set of hardware phantoms in accordance with another embodiment;

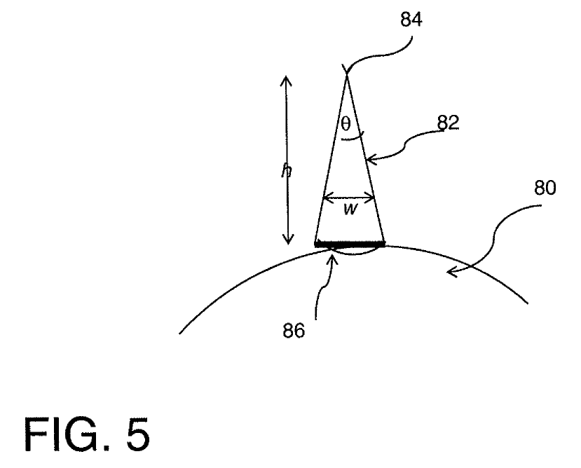

FIG. 5 is a greatly enlarged perspective view of a portion of one embodiment of a hardware phantom mimicking spicularity; and

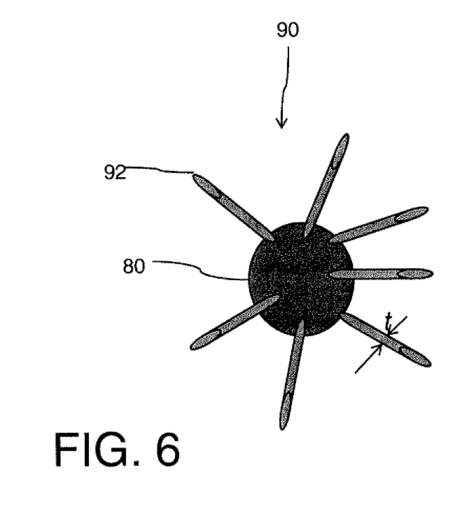

FIG. 6 is an enlarged perspective view of another embodiment of a hardware phantom mimicking vascularity.

With reference to FIG. 1, a functional block diagram of an imaging system 1 is shown. The illustrated system 1 facilitates computer aided diagnosis of imaged candidate tumors by allowing an automated or semi-automated evaluation of the imaging system's ability to resolve the structural features of the tumors and thus permit an accurate diagnosis to be formed using reasoned inferences based on measured parameters of these structural features. In the illustrated method, this is achieved by analysis using acquired image data from one or more hardware phantoms having known structural features that are designed to mimic the structural features of tumors under investigation, as described in greater detail below.

The imaging system includes a scanner 10. The illustrated scanner 10 is a computed tomography imaging scanner, although other medical scanning devices, such as magnetic resonance (MR), Positron Emission Tomography (PET), and Single Photon Emission Tomography (SPECT) scanners are also contemplated.

The scanner 10 includes a subject support 12, such as a table, couch, chair, or the like, for supporting a subject 14, such as a medical patient, during imaging. The support 12 is moved in a scanning direction z, into or within an examination region 16 that is defined by a rotating gantry 18 (shown in phantom for ease of illustration). A source of radiation 20 projects radiation into the examination region 16. The radiation source can be an x-ray tube which is arranged on the gantry 18 and projects a conical, wedge-, or fan-shaped x-ray beam 22 into the examination region 16 where it interacts with the imaging subject 14. Some portion of the x-rays are absorbed by the imaging subject 14 to produce a generally spatially varying attenuation of the beam. A two-dimensional x-ray detector 24 disposed on the gantry 18 across the examination region 16 from the x-ray tube 20 measures the spatially-varying intensity of the x-ray beam 22 after the x-ray beam passes through the examination region 16. Typically, the x-ray detector 24 is mounted on the rotating gantry 18. The detector 24 thus moves relative to the subject during imaging. In another suitable arrangement, the detector is arranged circumferentially on a stationary gantry surrounding the rotating gantry.

A drive system 26 controls the linear motion of the subject support 12 in the z direction and controls gantry rotation. In axial computed tomography imaging, the gantry 18 rotates while the subject support 12 remains stationary to effect a circular trajectory of the x-ray tube 20 about the examination region 16. In volumetric axial imaging, the subject support 12 is repeatedly stepped linearly in the z-direction, with an axial scan performed for each step to acquire multiple image slices along the axial direction. In helical scanning, data is acquired along a helical detection path produced by concurrent rotation of the gantry 18 and linear advancement of the support 12.

Acquired imaging projection data are transmitted from the detector 24 and stored in a digital data memory 30. A reconstruction processor 32 reconstructs the acquired projection data, using filtered backprojection or another reconstruction method, to generate a two- or three-dimensional image representation of the subject or of a selected portion thereof, which is stored in an image memory 34. The image representation is rendered or otherwise manipulated by a video processor 36 to produce a human-viewable image 37 that is displayed on a graphical user interface 38 or another display device, printing device, or the like for viewing by an operator. In one embodiment, the graphical user interface 38 is programmed to interface a radiologist with the computed tomography scanner 10 to allow the radiologist to execute and control computed tomographic imaging sessions.

The reconstruction processor 32 generates image data representative of a region of interest 40 of the subject 14. For example, the region of interest 40 is the subject's lungs when searching for nodules (tumors) indicative of lung cancer.

For differential diagnosis between benign and malignant tumors (e.g. lung nodules) the spicularity and vascularity tend to be the most significant clinical parameters. Automatic computerized quantification of spicularity and vascularity (and optionally other nodule shape characteristics), however, is highly dependent on the selected scan protocol (tube current, pitch, slice thickness), reconstruction method, image resolution, patient characteristics, etc. The quantitative results may therefore not be comparable between different CT scans and thus lead to erroneous diagnostic results. The illustrated embodiment solves this problem by scanning a hardware phantom with known spicularities simultaneously with the patient (or closely proximate thereto), so that the computerized quantification of the spicularity of candidate/actual patient tumors can be automatically calibrated against the spicularity of the phantom tumors. This enables a scan protocol independent and patient independent quantification and computer aided diagnosis.

As shown in FIG. 1, a hardware phantom assembly 50 is configured for scanning along with the subject 14. The illustrated hardware phantom assembly 50 includes a set of individual hardware phantoms or specimens 52, 54, 56, 58, etc. which mimic tumor structures and tumor physical properties (in the illustrated CT embodiment, x-ray absorption/transmission characteristics). The phantoms are three dimensional structures that differ from each other in their structural features. These differing structural features include the size of the phantom and the surface irregularities, as described in greater detail below.

Different regions of the body have different signal to noise ratios so it is desirable for the x-rays attenuated by the hardware phantoms 52, 54, 56, 58 to pass through the same region 40 of the body as the x-rays attenuated by the actual tumors undergoing diagnosis. In the embodiment of FIG. 1, for example, the hardware phantoms 52, 54, 56, 58 are encased in or otherwise supported by a casing 60, which is positioned closely adjacent the region of interest 40. For example, the casing is placed on the patient's chest when the region of interest 40 is the lungs. In this way, in a given scan, the hardware phantom assembly 50 and the region of interest are scanned substantially contemporaneously. Thus, x-rays attenuated both by the hardware phantoms and by a tumor in the region of interest 40 are received by the detector 24 and processed in a similar manner. In order to avoid possible anxiety of the patient caused by the sight of tumor-like structures, the casing 60 may be formed of a visually opaque but x-ray translucent plastic which fully encloses the individual hardware phantoms 52, 54, 56, 58. The casing 60 may be of a size comparable to that of the organ being examined. For lung tumors, the casing 60 may be about 20 cm in length, the typical length of the lungs.

In another embodiment, the phantom assembly 50 is mounted to the support 12, for example, on, within, or under the support, so that it moves along with the subject 14 through the examination region 16. In one embodiment, the support 12 serves as the casing 60. Such an embodiment is shown in FIG. 2, which may be similarly configured to the system of FIG. 1, except as noted, and where similar elements are accorded the same numerals. Here, the hardware phantoms 52, 54, 56, 58 are received within a cavity 62 in the support. Once again, the cavity 62 in which the phantoms are located is generally closely positioned to the region of interest 40. In another embodiment, the hardware phantoms 52, 54, 56, 58 may be integrated into the support during molding. In this latter embodiment, the hardware phantoms are distinguishable from the material of support by the scanning system, for example, by exhibiting differences in x-ray attenuation. Moreover, the exact location of each hardware phantom is indexed to the support position.

The illustrated hardware phantoms 52, 54, 56, 58 are each three-dimensional structures which mimic the structure of actual tumors (i.e., are not actual tumors). As illustrated in FIG. 3, hardware phantoms 52, 54, 56, 58 in the set are arranged in an array, such as a 4×4 or an 8×64 array of phantoms, or the like, each phantom 52, 54, 56, 58 differing in its structural features (e.g., size and/or shape) from the other hardware phantoms in the set. The hardware phantoms 52, 54, 56, 58 are formed of a material such as rubber or plastic, which has a similar response to the radiation to a tumor of interest. For example, the material may have a similar density to common tissue. In the case of a CT scanner 10, the material(s) selected for the phantoms have similar x-ray attenuation properties to the tumors of interest. In MR, the phantom has a similar MR response, and so forth for other imaging modalities.

The similarity in structural features and attenuation properties to actual tumors allows an assumption to be made that if a known structural feature of one of the hardware phantoms 52, 54, 56, 58 has been detected in a scan, i.e., is resolvable by the system 1, then similarly sized and shaped structural features of an actual tumor in the subject are likely to be detectable, to the extent they exist. Similarly, if a known feature of one of the hardware phantoms 52, 54, 56, 58 has not been detected in a scan, for example, because it is of a size which is below the detection threshold of the scanner 10 at the selected scan settings, then similarly sized and shaped features of a tumor in the same scan are likely not to be detectable, even if they exist.

This estimation regarding the likely detectability of tumors can be used, for example, by a radiologist, or other medical observer, in visual observation of the reconstructed image. A reconstructed image 63 of all the hardware phantoms captured in the scan may be displayed adjacent the image 59 of a candidate tumor or other region of interest on the screen for ease of comparison. The radiologist is instructed that if the smaller phantoms and/or the smaller structural features of the phantoms are visible (resolved) in the reconstructed image, then the absence of similar features in the candidate tumor or region of the subject can be inferred to indicate that the features do not exist; whereas, if certain structural features of the hardware phantom are not visible in the reconstructed image, the radiologist should not draw any conclusions about the lack of analogous features of any tumors in the subject.

The hardware phantom assembly 50 is also applicable to computer aided diagnosis. In particular, it enables computer aided diagnosis to be more accurate by restructuring the inferences which the diagnosis relies upon in a similar manner to the visual diagnosis. As shown in FIG. 1, a computer aided diagnosis system 64 is coupled to the reconstruction processor 32 and provides a diagnosis based at least in part on the reconstructed image data. The diagnosis system 64 may be embodied in software, hardware or a combination of the two. In the illustrated embodiment, the diagnosis system 64 accesses a database 66 that stores data derived from prior scans of tumors. The diagnosis system 64 compares image data for previously located suspected tumors, and provides a differential diagnosis of each tumor under watch to determine a change in size or shape from which a probability of whether the tumor is likely to be benign or malignant can be deduced.

In another embodiment, the diagnosis system 64 compares image data for a new tumor under examination with the previously acquired data for other tumors stored in the database 66. Based on the comparison, the diagnosis system 64 provides a differential diagnosis of the tumor under examination, such as a probability of whether the tumor is likely to be benign or malignant.

The diagnosis system 64 may be fully automated or partially automated. For example, in a partially automated system, a radiologist identifies the location(s) of any tumor candidates (suspected tumors) in the image. In one embodiment, the radiologist also identifies the locations of the phantoms 52, 54, 56, 58 in the same image or a closely adjacent image from the same scan. The radiologist then compares the tumor candidates with the hardware phantoms to assist in the diagnosis. If the radiologist cannot see the smaller features of the hardware phantom in the image, inferences about the state of the candidate tumor are impacted accordingly.

In a more automated embodiment, the locations of the phantoms and candidate tumors are identified automatically. For example, the locations of the phantoms are determined from an image created by appropriately positioned markers 68 on the casing 60, by the casing itself, such as the casing edges, or by analyzing known relative locations of the phantoms themselves. Accordingly, the location of a structure which, because of its small size, is absent from the image or difficult to detect, can be determined using appropriate reconstruction software. Generally, a minimum of three markers 68 or casing locations are needed to fix the locations of all the structures, since the structures remain in known fixed positions within (or on) the casing. In one embodiment, each structure has its own associated marker, as shown in FIG. 3.

The structural features by which the hardware phantoms 52, 54, 56, 58 in the set are distinguishable from each other include those features which are typically used to characterize a tumor as being benign or malignant and include features which are designed to test the detection capability of the scanner 10. One of these features is the size of a hardware phantom. As shown in FIG. 4, the set of hardware phantoms (eight phantoms 52, 54, 56, 58, 70, 72, 74, and 76 being shown by way of example) includes hardware phantoms of a plurality of different sizes (four different sizes s₁, s₂, s₃, and s₄ are shown by way of example). The phantom size may be determined for example, as the diameter of a body portion 80 of the respective hardware phantom. For example, hardware phantoms 52, 54, 56, 58 in the set have sizes in the range of about 1-30 mm, or less. For example, phantoms of from about 3 mm to about 30 mm may be employed (e.g., phantoms of 3, 5, 10, and 30 mm). These sizes are typical of the small nodules found in cancerous lung tissue which are detectable with current imaging techniques. Other sizes may be appropriate for different types of tumor and/or where there are different limits to the resolution of the imaging system 1.

Another structural feature is the irregularity of the surface of the hardware phantom, which in the case of a tumor, is generally referred to as spicularity. The degree of spicularity can be defined in terms of some measure of one or more of the structural features of the tumor. In a tumor such as a lung nodule, spiculi (fine, often tapered, spike-like projections) extend from a body of the tumor in all directions. A measure of some function of various parameters of the spiculi is used in the differential diagnosis, based on prior experience as to the importance of each of these parameters to the diagnosis. For example, one or more of the diameter (width), height, volume, and/or number of the spiculi may be used in the diagnosis.

In the case of the hardware phantoms, at least some of the phantoms have varying degrees of surface irregularity to mimic different degrees of spicularity. As shown in FIG. 4, for example phantoms 52, 54, 56, 70, 72, and 74 include spikes 82 which radiate from the respective body portion 80 to mimic the spiculi on a tumor body. One or more of the phantoms 58, 76 may be smooth, and have no spikes or other projections.

As illustrated in FIG. 5, the spikes 82 are generally conical in shape and have a size which can be expressed in terms of parameters such as height, width, taper, volume, or some combination of these. The illustrated spike has a height h (e.g., as measured in a direction normal to the surface of the body 80), width w (which may be expressed as the mean diameter, minimum or maximum diameter or other appropriate consistently determined width measurement). The illustrated spike 82 is also tapered, as illustrated by angle θ, from a tip 84 to a base 86 of the spike in a similar manner to naturally occurring spiculi. The spikes 82 extend from the body in multiple directions so that the reconstructed image should show at least some of the spikes if they are within the resolution of the system 1. Different degrees of spicularity between the various phantoms are evident, for example, in differences in the parameters, such as differences in height h, width w, and or taper θ, of the spikes and optionally also their number. One or more of the phantoms in the set has spikes in which the values of the size parameter(s), such as the height, width, or volume of the smallest spikes 82, is generally at about the expected limit to resolution of the imaging system 1. This enables the point at which the imaging system is able to resolve small spiculi to be detectable from the reconstructed images of the hardware phantoms. For example, as shown in FIG. 4, the set of phantoms includes phantoms with spikes of different widths/tapers, such as a first phantom 54 with spikes of a first width/taper, a second phantom 56 with spikes of a second width/taper but of similar height h, and so forth. Similarly, a first phantom has spikes of a first height and another phantom has spikes of a second height, and may have a similar taper. The different structural features of the phantoms, in addition to enabling the resolution of the imaging system to be evaluated and taken into consideration in the differential diagnosis, also facilitate calibration of the system by providing structures of known sizes s₁, s₂, s₃, s₄, from which the sizes of the tumors and spiculi in the images can be computed.

Another structural feature which is often used in the differential diagnosis of tumors is vascularity. This refers to the extent to which blood vessels are connected with the tumor. In one embodiment at least some of the tumor phantoms are configured as shown in hardware phantom 90 of FIG. 6. Each of the phantoms 90 is intended to mimic different degrees of vascularity and has needle shaped projections 92, which extend from a generally spherical body portion 80. A first phantom may have projections 92 of a first thickness t and a second phantom may have projections 92 of a second thickness different from the first thickness, and so forth. The exemplary projections 92 are similar to the spikes 82, but are optionally hollow and generally lacking in taper.

As will be appreciated, the variations in spicularity and vascularity mimicked by the tumor phantoms proposed here are exemplary only. In other embodiments, there may be different distinguishable structural features, such as different types of spikes (e.g., differing in height, width and/or taper) on a single phantom. The body portion 80 may be of a different shape from the spherical shape shown. The spikes 82 and/or needle shaped projections 92 may be curved rather than being regular cones or cylinders as shown. The spikes or projections may be non-uniformly distributed around the body, rather than uniformly arranged, as shown. The spikes may be truncated cones without a tip. Indeed virtually any structural feature which is required to be taken into account in the automated or manual differential diagnosis of the tumor may be a feature represented by two or more parameter values among the various hardware phantoms.

The exemplary diagnosis system 64 includes a calibration component 100 which receives as input, the known locations and parameters (dimensions, etc.) of the structural features (spikes, projections, etc) of the tumor phantoms. The parameters may be stored in associated memory 102. The calibration component correlates each phantom with its location and determines the dimensions of the corresponding identifiable structural features of the phantoms in the reconstructed image to provide calibration parameters for the image. This enables parameters of structural features of the actual tumor, such as body size, spiculi heights and widths, etc., to be determined, based on the calibration parameters derived from the known dimensions of the tumor phantoms. The exemplary computer aided diagnosis system 64 further includes a detection component 104, which receives as input, the calibration for the image and identifies any structural features of the phantoms (e.g., spikes, projections or even an entire phantom) which should have been detected due to their determined location but which are at least partially absent from the reconstructed image data. Based on this information, the detection component updates a classifier 106. The classifier 106 classifies tumors (e.g., as having a probability of being either malignant or benign) based, at least in part, on their structural features using previously acquired data on classified tumors stored in database 66.

In one embodiment, the CAD system 64 also aids in identification of candidate tumors in the image. In this embodiment, the system 64 includes a search and compare routine 108 which compares subregions of the image of the subject with images of the phantoms to identify tumor candidates that resemble one or more of the phantoms. A marking component 110 marks each tumor candidate. For example, the marking component 110 can cause the video processor 36 to draw a circle around each tumor candidate. The circles could be color coded to identify the phantom which the marked candidate resembles. As another example, a list of the tumor candidates by image coordinates and phantom similarity can be generated. Other marking techniques which enable the oncologist to find and examine each candidate tumor in the diagnostic image are also contemplated. In one embodiment, a patient diagnosis routine 112 analyses the number of candidates corresponding to each phantom and generates a probability of malignancy or other suggested diagnosis.

An exemplary method proceeds as follows. The hardware phantom assembly 50, which mimics different tumor sizes and varying degrees of tumor spicularity/vascularity, is scanned together with the patient (e.g., with a CT or MR scanner). Image data acquired during scanning is processed by the reconstruction processor 32 to generate one or more reconstructed image(s). Dimensions and other parameters of the hardware phantoms, as they appear in a reconstructed image, are measured. A calibration is then performed for the image using the known dimensions of the hardware phantom. This allows the heights, widths, tapers, etc. of spiculi and/or blood vessels of the imaged tumors to be determined relative to the known sizes of the spikes and/or projections shown in the images. Known structural features of the hardware phantom which are not detectable in the image data (such as projections below a certain height and or width) are identified. This information is used to modify the inferences used in the differential diagnosis and/or the confidence estimates for the diagnosis. Candidate tumors in the image are identified, for example, by identifying shapes in the image with similar gray levels (attenuation) and structural features to those of the reconstructed images of one or more of the hardware phantoms. Parameters, such as dimensions of structural features of each candidate tumor, as it appears in the image, are determined, based on the calibration. The computerized quantification of the spicularity of true patient tumors can thus be automatically calibrated against the spicularity of the phantom hardware phantoms. The calibrated tumor parameters are compared with data from prior evaluations which are categorized according to diagnosis. The information gained from the hardware phantom is used to ensure that the diagnosis is not based on an incorrect inference. In particular, an inference based on an observed lack of small spiculi is avoided when the phantom image data indicates that such spiculi are not detectable. A differential diagnosis is output based on the comparison. The differential diagnosis may be in the form of a probability that the tumor(s) is malignant together with a confidence estimate. For example, one output may be that a detected tumor or set of tumors have an 80% probability of being malignant and that the confidence of this estimate is 90%. Or, the diagnosis may be in the form of computed data which may be utilized by a radiologist and/or other medical personnel as a basis for forming a diagnosis. In general, the confidence estimate increases when the resolution of the imaging system is determined to be greater, e.g., when more of the smallest projections on the hardware phantoms are detectable.

In another embodiment, a radiologist examines the reconstructed image to identify a shape in the image corresponding to a tumor and makes a manual diagnosis assessment, such as whether or not the tumor is malignant or benign. In this embodiment, a reconstructed image 63 of the tumor phantoms, or a representation thereof, may be displayed on the screen at the same time as the tumor of interest for ease of comparison. Computed information on the minimum size of the tumor spiculi which can be expected to be seen in the image, based on computation for the hardware tumor phantoms, may also be displayed. The radiologist may make a diagnosis based on prior experience for similar types of tumor or by comparing the tumor in the image with a prior image acquired from the same tumor or region of interest.

In one embodiment, a computer program product encodes instructions which when executed by a computer, perform the computer implemented steps performed by the computer aided diagnosis system 64. The computer program product includes instructions for performing at least some of the steps for performing the exemplary differential diagnosis method described above. The computer program product may be a tangible computer-readable recording medium on which a control program is recorded, such as a disk, hard drive, or may be a transmittable carrier wave in which the control program is embodied as a data signal. Common forms of computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, transmission media, such as acoustic or light waves, such as those generated during radio wave and infrared data communications, and the like, or any other medium from which a computer can read and use.

The exemplary embodiment finds application in CT/MR scanners as well as with CAD-software packages on CT/MR/PET scanner consoles, imaging workstations (e.g. Extended Brilliance Workspace, ViewForum), and PACS workstations (e.g. iSite). The disclosed system and method can be used in the context of primary diagnosis as well as in follow-up monitoring.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. An imaging system comprising:
at least one hardware phantom which includes structural features that mimic different structural features of tumors;
a scanner which acquires image data for a subject in a region of interest and the at least one hardware phantom; and
a reconstruction processor which processes the image data to generate reconstructed image data representative of the region of interest and of the hardware phantom.

2. The imaging system of claim 1, further comprising:
a diagnostic system which computes parameters of structural features of an identified tumor based on the reconstructed image data for forming a diagnosis concerning the tumor in which the imaging system's ability to resolve the different structural features of the at least one hardware phantom informs the diagnosis.

3. The imaging system of claim 1, further comprising:
a diagnostic system which compares the structural features of the phantom with the image of the subject to identify tumor candidates.

4. (canceled)

5. The imaging system of claim 1, wherein the at least one hardware phantom includes a set of hardware phantoms, wherein the structural features of at least some of the hardware phantoms include projections which extend from a respective body of the hardware phantom, the projections of at least one of the hardware phantoms differing from the projections of at least another of the hardware phantoms.

6. (canceled)

7. The method of claim 1, further comprising a casing which houses the at least one hardware phantom wherein the casing includes a plurality of markers which enable locations of hardware phantoms in the reconstructed image to be determined.

8. (canceled)

9. The imaging system of claim 1, wherein the scanner includes a support for supporting the subject, the at least one hardware phantom being mounted to the support for movement therewith, wherein the support includes a cavity which holds the at least one hardware phantom.

10. The imaging system of claim 1, wherein the at least one hardware phantom is formed of a material which exhibits a similar response to the scanner to that of an actual tumor in the region of interest.

11. The imaging system of claim 10, wherein the scanner comprises a computed tomography scanner and wherein the material of the at least one hardware phantom attenuates x-rays in a similar manner to an actual tumor in the region of interest.

12. The imaging system of claim 1, further comprising memory which stores parameters of the structural features of the at least one hardware phantom, the diagnostic system comparing parameters of the structural features of the at least one hardware phantom in the reconstructed image data with the stored parameters.

13. (canceled)

14. (canceled)

15. A method of imaging comprising:
in the same scan, acquiring image data for a subject in a region of interest together with image data for at least one hardware phantom; and
processing the image data to generate reconstructed image data representative of the region of interest and of the at least one hardware phantom.

16. The method of imaging of claim 15, further comprising:
computing parameters of structural features of an identified tumor candidate in the region of interest from the reconstructed image data;
computing parameters of structural features of the at least one hardware phantom from the reconstructed image data; and
estimating an ability to resolve at least some of the structural features of the tumor candidate from the computed parameters of the structural features of the hardware phantom.

17. The method of imaging of claim 16, further comprising:
forming a diagnosis concerning the identified tumor candidate based on the computed parameters of the structural features of the tumor candidate, the diagnosis being informed by the estimated ability to resolve the structural features of the tumor candidate.

18. The method of claim 15, wherein the structural features of the at least one hardware phantom comprise at least one of spikes and projections which extend from a body portion of at least one of the at least one hardware phantoms.

19. (canceled)

20. The method of claim 16, wherein the structural features of the tumor candidate comprise at least one of spiculi and blood vessels.

21. The method of claim 20, wherein the estimating the ability to resolve at least some of structural features of the tumor candidate comprises estimating a parameter value below which spiculi are not expected to be resolved or above which spiculi are expected to be resolved.

22. The method of claim 20, wherein the parameters of the structural features of the tumor candidate include at least one of the group consisting of height, width, taper, and volume of the spiculi or blood vessels.

23. The method of claim 22, wherein the parameters of the structural features of the tumor candidate further include a number of the spiculi or blood vessels.

24. The method of claim 15, wherein the at least one hardware phantom comprises a set of different hardware phantoms.

25. The method of claim 24, further comprising:
computing parameters of structural features of a first of the hardware phantoms and computing parameters of structural features of a second of the hardware phantoms from the reconstructed image data.

26. The method of claim 24, further comprising:
electronically comparing the hardware phantoms with the image of the subject to identify tumor candidates.

27. The method of claim 26, further comprising:
storing parameters of the structural features of the hardware phantoms in memory and evaluating the tumor candidates in accordance with the stored parameters to generate a proposed diagnosis.

28. The method of claim 27, wherein the forming of the diagnosis concerning the tumor candidate comprises determining a probability that the tumor is malignant.

29. (canceled)

30. A method of analyzing image data comprising:
computing parameters of structural features of a candidate tumor represented in reconstructed image data acquired in a scan of a subject;
computing parameters of structural features of at least one hardware phantom represented in the reconstructed image data acquired in the scan of the subject; and
estimating an ability to resolve at least some of the structural features of the candidate tumor from the computed parameters of the structural features of the hardware phantom.

31. (canceled)
